(19) United States
(12) Patent Application Publication
(10) Pub. No.: US 2015/0167627 A1
(43) Pub. Date: Jun. 18, 2015

(54) H2O Gravity Flow Generator

(71) Applicant: Amadeo Caro Villanueva, JR., FPO (AE)

(72) Inventor: Amadeo Caro Villanueva, JR., FPO (AE)

(21) Appl. No.: 13/860,380

(22) Filed: Apr. 10, 2013

(51) Int. Cl. F03B 13/06

(52) U.S. Cl. CPC F03B 13/06; Y10S 415/916; F03B 17/005

(57) ABSTRACT

The invention provides a new method to produce renewable energy by recycling water or any kind of liquid in close loop system by using containers to constantly rotate a shaft on mechanical and hydraulic devices to operate electrical generators.

### CROSS-REFERENCE TO RELATED APPLICATIONS

This application is in reference to a Provisional Patent I filed in Jul. 05, 2012. Application No. 61/690,806.

### BACKGROUND OF INVENTION

The invention pertains to the field of renewable energy and clean energy technology. The invention produces electricity 24 hours a day, seven days a week, 365 days a year by recycling water. Present day renewable energy to produce electricity comes from resources that are easily replenished such as sunlight, wind, rain, tides, waves, and geothermal heat. There are problems associated with present day technology in the renewable energy field. Sunlight required by solar panels to produce electricity is not available 24 hours day and solar energy requires many solar panels, occupying plenty of land space to produce electricity for a town or city. Wind is not always present for Wind Turbine to produce electricity and its large rotating blades produces disruptive vortices requiring wind turbine to be spaced a certain distance from each other. These Wind Farms uses plenty of land space and its large rotating blades are considered environmentally a threat to wild life birds. Renewable energy technology requiring tides and waves to produce electricity are not always available to towns and cities located further inland away from rivers and costal area. Geothermal heat produces electricity through the use of heat obtain from pipes drilled into the earth. Geothermal works in regions containing hot rocks located deep into the earth soil which is not available in all locations. These hot rocks after a period of time can cool off because of the injected water to produce steam. This steam is toxic and is used to turn a generator. Present day technology which produces electricity are usually located away from towns and cities requiring many miles of wooden or steel polls to suspend transmission lines made of aluminum and steel which adds to the cost to supply electricity and unnecessary waste of natural resources.

### BRIEF SUMMARY OF THE INVENTION

The present invention, the H2O Gravity Flow Generator, involves in one embodiment a unique method of producing electricity by the use of recycled water and gravity. Researching the United States Department of energy, this invention is not used as a source of clean renewable energy to produce electricity. The advantage of the invention over present renewable energy technology is that it produces electricity 24 hours a day, seven days a week, 365 days a year by recycling water. The invention produces electricity in close proximity to towns and city using less land space, transmission lines, and natural resource used in transporting electricity from present day alternative energy sources. The invention can be built as part of or installed in apartment buildings and high rises in big cities providing electricity to apartments of the building, surrounding buildings, and for public or private electric transportation. The invention will help the economy reduce the high demand of coal, oil, and natural gas used to produce electricity used in homes, offices, business, and transportation.

The invention, H2O Gravity Flow Generator, produces electricity by releasing a plastic tank full of water suspended at the top of a steel frame structure connected to a reel by a high strength rope or cable. The weight of water and the gravity force descends the plastic tank full of water to ground rotating a reel connected to a shaft rotating a gear box connected to a planetary gear box to rotate the shaft of a hydraulic pump to rotate the shaft of hydraulic motors to turn the shaft of an electrical generator to produce electricity. Before the plastic tank full of water reaches the ground, a second reel connects to the shaft and the plastic tank connected to it is released from the top of the steel structure keeping the shaft in a rotating motion to continue the operation of the electrical generators to produce electricity. When the plastic tank reaches the ground the water is released from the tank which flows through a discharge pipe and into a plastic reservoir and recycled back to the top of the steel structure. The empty plastic tank is raised back to the top of the steel structure and filled with the recycled water. The process is repeated for each plastic tank in a cyclic order to constantly rotate the shaft of the gear box to operate the electrical generator.

### BRIEF DESCRIPTION OF DRAWINGS

FIG. 1 is a steel structure (1) comprising of a pulley system (2), a top water plastic reservoir container (3), a water distribution box (4) connected to water distribution pipes (5) to distribute water to the plastic tanks (6) suspended from the structure. The plastic tank full of water (6) is released from the top and descends to the bottom by a high strength rope or cable (7) connected to a reel (8) which rotates the shafts of gear boxes and hydraulic pump (9) to operate the hydraulic motors (10) to rotate the electrical generator (11) shaft at higher speeds. Components (8), (9), (10), and (11) is further described in FIG. 2 page 2/3 of drawings. When the plastic tank (6) reaches the bottom, the water is released and flows through a discharge pipe (12) to a bottom plastic water reservoir (13) then recycled back to the top water reservoir (3) by the use of an electric pump (14) and a water pipe (15). Item (16) is part of the steel structure (1) used as a rail to guide the plastic tank into the discharge pipe (12).

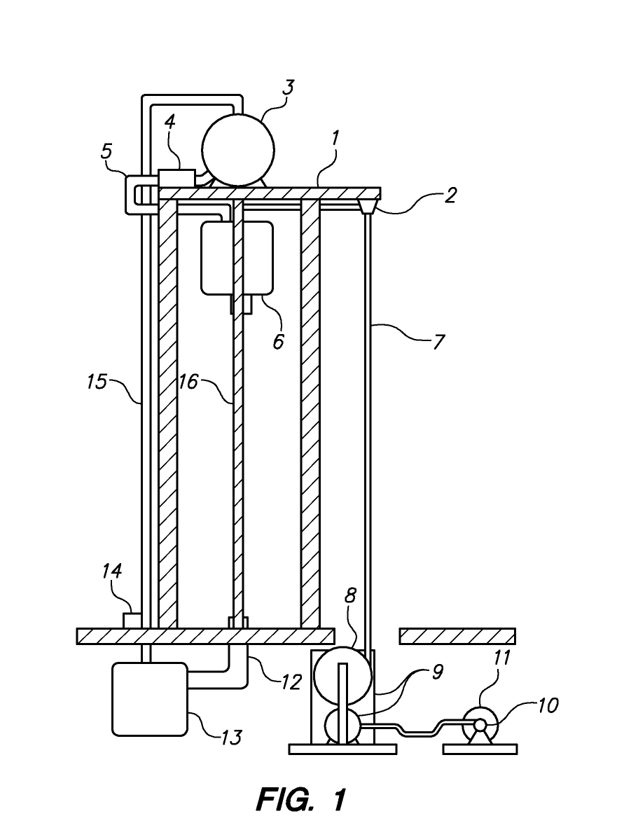

FIG. 2 is a brief description of the rotating reels, planetary gear boxes, hydraulic pump, hydraulic motors and electric generators. FIG. 2 consist of a steel frame (1) containing four reels (2) in which the shaft (3) spins freely. The clutch mechanism (4) connects and disconnects the reels (2) to the shaft (3). The shaft rotates a 1:1 gear box (5) interfacing two planetary gear box (6) which rotates two hydraulic pumps(7). The hydraulic pumps, pump hydraulic fluid from the hydraulic reservoir (8) to operate the hydraulic motors (9). The shafts of the hydraulic motor turn at higher speeds and torque to rotate the shaft of the electrical generators (10). Item (11) is a high strength rope or steel cable connected to the reel (2) and a plastic water tank (FIG. 1 (6)). Item (12) are electric motors that rotates the reels in the opposite direction from decent when disengage from the shaft to hoist the empty plastic tank back to the top of the structure. Item (13) are post to hold the clutch mechanism which connects and disconnect the reel to the shaft.

FIG. 3 is a drawing showing a steel structure (1) and four plastic tanks. Plastic tank one (2), plastic tank two (3), plastic tank three (4), and plastic tank four (5) each connected to a reel illustrated in FIG. 2 item (2). When plastic tank item (2) reaches the bottom of the steel structure, water is released from plastic tank (2) and flows through discharge pipe (6) into a bottom plastic reservoir (7). Water flows from the bottom reservoir (7) back to the top reservoir (9) by a high speed electric pump (8) connected to a water pipe (10). Item (11) is a high strength rope or steel cable connected to a reel (FIG. 2, (2)). Item (12) is a steel tube frame containing wheels and a loop at the top to connect a rope or cable (11) to guide the plastic water tank from the top of the structure to the bottom to connect to the discharge pipe. Item (13) are shafts that extends and retract to lock the suspended containers into position until the time to be released.

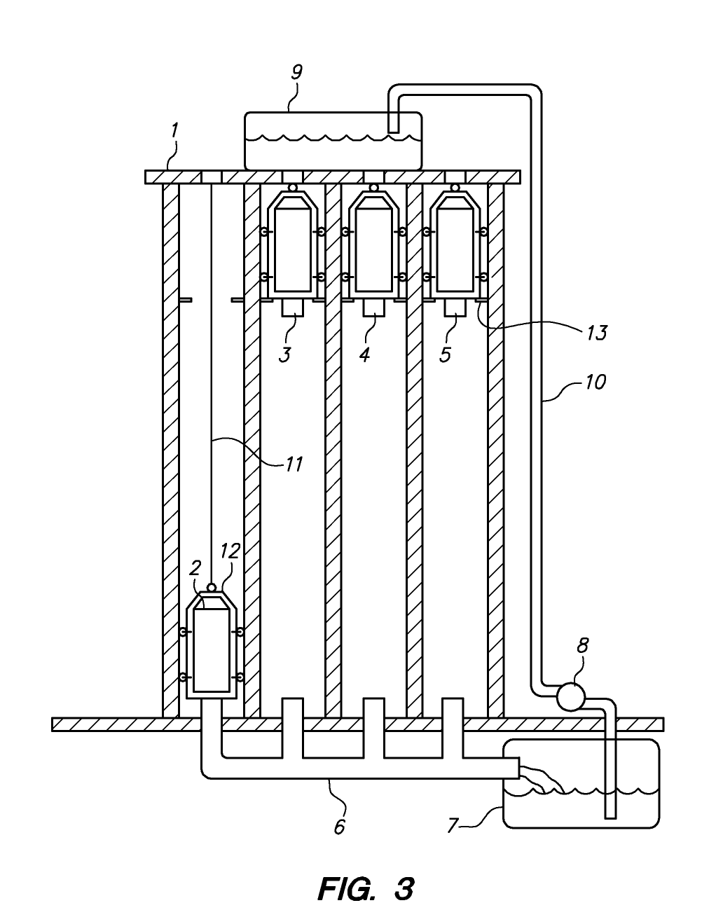

### DETAILED DESCRIPTION OF THE INVENTION

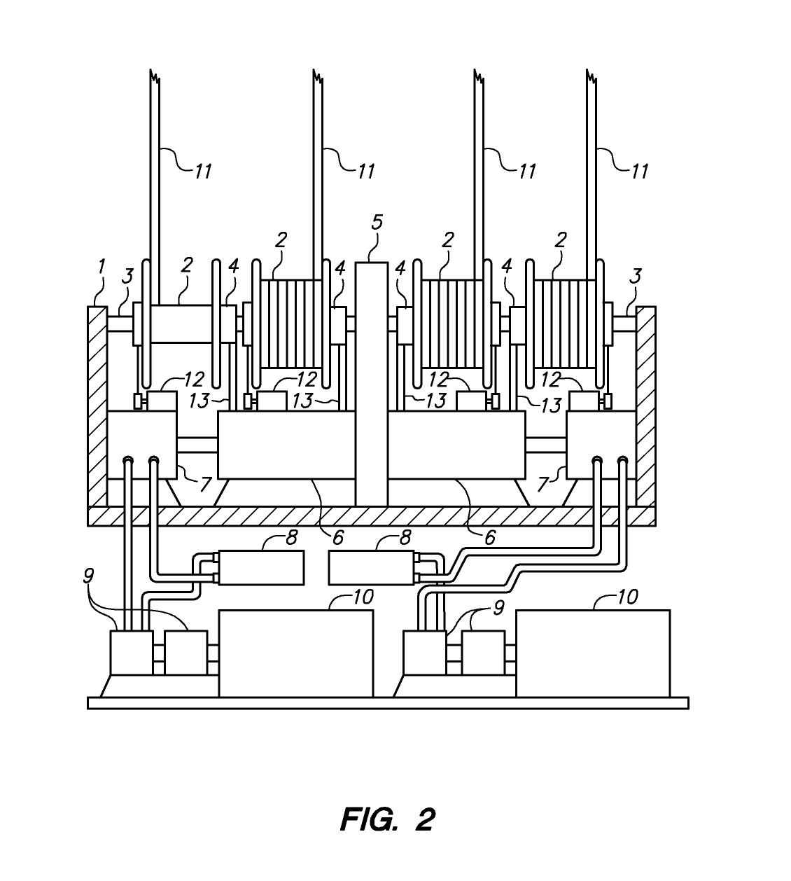

The process of making the invention involves building a vertical frame structure preferably made of steel beams, enclosed, and having a height of 120 ft or more. The top of the steel structure contains extended beams with a pulley system in which a rope connects to a plastic tank and a reel at the bottom of the structure. The steel structure also contains a Platform to support a stationary reservoir made of heavy gauge plastic to store, hold and distribute liquid, preferably water. The top Platform also contains a water distribution box containing valves. A pipe from the plastic reservoir at the top of the structure, connects to the valves in the water distribution box to distribute water two or more thick gauge plastic tanks suspended from the frame structure by the pulley systems and rope attached to a reel system at the bottom of the steel structure. The plastic tank is encased in a metal tube frame containing wheels to guide the tank to the bottom of the structure and a loop at the top of the frame to connect to a rope or cable. The tube frame with the plastic tank full of water is locked to the structure with a hydraulic operated mechanism. The hydraulic operated mechanism is attached to the steel frame structure which extends and retracts a shaft. The shaft in the extended position holds the plastic tank full of water at the top of the steel structure. When the shaft retracts, the plastic tank full of water is released and descends to ground. The wheels on the tube frame of the plastic tank guides the tank to the bottom to connect to the discharge pipe. As the plastic tank descends, the rope or cable attached to the tube frame of the plastic tank rotates a reel located at the bottom of the structure. A steel frame structure at the ground (FIG. 2), preferably underground inside a basement structure, contains reels, shaft, a gear box that interfaces with two planetary gear box, and two hydraulic pumps. A shaft supported by bearings at each end of the frame structure contains reels spinning freely around the shaft. A hydraulic clutch mechanism slides a collar on the shaft meshing a grove plate to the grove plate of the reel connecting the reel to the shaft. The shaft of the connected reel rotates as gravity forces the plastic tank to the ground. The reel connected to the shaft rotates a 1:1 ratio gear box that rotates two planetary gear boxes to increase the RPM (Revolution Per Minute) required to operate the hydraulic pump. Each hydraulic pump drives hydraulic motors which rotates a generator to the required speed and torque to produce electricity. The decent of the plastic water tank is controlled by one or both the hydraulic pump. The torque required by the hydraulic pump and gear boxes slows the decent to the proper RPM and to increase the time it takes the plastic tank of water to travel from the top to the bottom of the steel structure to connect to the discharge pipe. Additional disk braking system can be added to the shaft of the reels and the shaft of the planetary gear box to slow the decent to provide the proper RPM for the planetary gear boxes and to increase the decent time. Before the plastic tank reaches the bottom, one of the other reels on the shaft is engaged and the suspended plastic tank full of water connected to it is released keeping the shaft rotating in one direction as it descends to the bottom. As the plastic tank reaches the bottom it connects to the discharge pipe which lifts a spring loaded plug in the close position inside the tank, releasing the water. The water flows through the discharge pipe and into the bottom plastic reservoir. When the tank connects to the discharge pipe the clutch of the reel for that tank disengages the reel from the shaft. When the tank is done discharging the water through the discharge pipe, an electric motor hoist the plastic tank to the top of the steel structure and locked into position until it is released again. The water is recycled back to the top plastic water reservoir by 20 hp or more electric pump connected to a pipe. The pipe moves water from the bottom plastic water reservoir to the top plastic water reservoir.

The above process of releasing the plastic tank full of water to rotate a reel, recycling the water, and hoisting the plastic tank to the top of the structure to operate an electric generator to produce electricity is repeated for each suspended plastic tank. Suspended plastic tank 1 is released and before it reaches the ground, suspended plastic tank 2 is released. Before plastic tank 2 reaches the ground, suspended plastic tank 3 is released. Before plastic tank 3 reaches the ground, suspended plastic tank 4 is released. Before plastic tank 4 reaches the ground, the process is repeated and plastic tank 1 is released from the top again. The end result of the cyclic process is to keep the shaft rotating to produce electricity by using the weight of recycled water and gravity.

1. I, Amadeo Caro Villanueva Jr., claim a unique method and device for producing renewable energy through the use of recycled liquid in one or more container suspended from a vertical or incline structure which moves from one end of the structure to the other end by gravity recycling the liquid from the bottom of the structure back into the container at the top of the structure to rotate a reel connected to the moving container by a rope or cable which connects and disconnects to a shaft to rotate components of mechanical and hydraulic devices to rotate the shaft of equipment and generators used to produce electricity.

2. The container recited in claim 1 moves liquid from a height above ground to a lower height preferably ground or below ground discharging the liquid into a stationary container to be move back to the top, recycling liquid in a close loop system to rotate a reel connected to a shaft.

3. The reel recited in claim 1 is part of a frame structure consisting of one or more reels used to engage and disengage a shaft by a clutch mechanism to rotate a gear box interfacing one planetary gear box on one side (left side of the gear box) and a second planetary gear box on the other side (right side of gear box) each rotating a hydraulic pump used to operate hydraulic motors to rotate equipment and generators to produce electricity.
